(19) United States
(12) Patent Application Publication
(10) Pub. No.: US 2004/0243552 A1
(43) Pub. Date: Dec. 2, 2004

(54) Method, system, and apparatus for viewing data

(75) Inventors: Robert G. Titemore, Lexington, MA (US); Keith W. Boone, Randolph, MA (US); Jeffrey G. Hopkins, Lincoln, RI (US); Cameron Fordyce, Providence, RI (US); Harry J. Ogrinc, Westwood, MA (US); Nathaniel E. Brooks, Winchester, MA (US)

Correspondence Address: HOWREY SIMON ARNOLD & WHITE LLP, ATTEN: MARGARET P. DROSOS, DIRECTOR OF IP ADMIN, 2941 FAIRVIEW PARK DR, BOX 7, FALLS CHURCH, VA, 22042, US

(73) Assignee: Dictaphone Corporation, Stratford, CT

(21) Appl. No.: 10/448,325

(22) Filed: May 30, 2003

(51) Int. Cl. G06F 17/30

(52) U.S. Cl. 707/3

(57) ABSTRACT

In a method of viewing data, a set of documents and associated metadata is received based on a set of query parameters. Query hits are determined within the set of documents for a selected extraction target of a plurality of extraction targets. The query hits are associated with the selected extraction target. The plurality of extraction targets is displayed, where each extraction target being a link to associated query hits from the set of documents.

### CROSS-REFERENCE TO RELATED APPLICATIONS

This application relates to co-pending U.S. patent application Ser. No. 10/413,405, entitled, “INFORMATION CODING SYSTEM AND METHOD”, filed Apr. 15, 2003; co-pending U.S. patent application Ser. No. 10/______, entitled, “SYSTEMS AND METHODS UTILIZING NATURAL LANGUAGE MEDICAL RECORDS”, filed on May 29, 2003; co-pending U.S. patent application Ser. No. 10/______, entitled, “METHOD, SYSTEM, AND APPARATUS FOR VALIDATION”, filed on May 30, 2003; and co-pending U.S. patent application 10/______, entitled, “METHOD, SYSTEM, AND APPARATUS FOR DATA REUSE”, filed on May 30, 2003; all of which co-pending applications are hereby incorporated by reference in their entirety.

### BACKGROUND OF THE INVENTION

It is generally known that various governmental agencies, businesses, health care institutions or other similar entities generate many reports. For example, a metropolitan police department may generate arrest reports for the people arrested by the members of the police department. In the medical industry, physicians, nurses and health care administrators generate voluminous patient records.

The volume of the records has placed a burden on these entities with regards to accessing, searching and/or reusing the information contained in the records. These entities have attempted to use electronic records to reduce the space requirement for physical records and to improve the searching of records. For instance, in the healthcare industry, institutions have turned to electronic medical records (EMR) to alleviate storage issues and/or to improve search capabilities for records. The typical EMR system includes a specialized interface to create the EMR. The EMR is then stored in a database for retrieval and search.

The conventional EMR systems may also be limited in displaying the surrounding text of a search item. More particularly, the EMR system may be configured to locate an EMR based on key fields. However, the EMR system cannot typically display the surrounding text of a selected key field. As a result, if a health care professional wants to view the text of a medical report describing or providing more information about a certain condition, the health care professional may take the time necessary to search for the appropriate document(s) and scan for the information in the located document(s) or do without.

Another drawback and disadvantage to conventional EMR systems is that they typically do not permit the insertion of free-form text, i.e., dictated text, into the EMR. More specifically, data is entered for an EMR through a specified graphical user interface (GUI) of the conventional EMR system. This interface is typically complicated and very time consuming for a healthcare professional to utilize. Further, the GUI may not permit the insertion of free-form text within the EMR. Although some conventional EMR systems import or link the free-form text with the EMR, these systems still do not offer the capability of searching in the free-form text.

### SUMMARY OF THE INVENTION

An advantage exists in the present invention that facilitates the viewing of a document by providing a mechanism for presenting and organizing relevant data from external sources.

In a first aspect, the present invention includes an embodiment that relates to a method of viewing data. The method includes receiving a set of documents and associated metadata based on a set of query parameters and determining query hits within the set of documents for a selected extraction target of a plurality of extraction targets. The method also includes associating the query hits with the selected extraction target and displaying the plurality of extraction targets, each extraction target being a link to associated query hits from the set of documents.

In a second aspect, the present invention includes an embodiment that pertains to a method of viewing data. The method includes providing a plurality of documents, where each document is associated with annotated facts. The method also includes selecting a group of documents based on a predetermined criteria and aggregating the annotated facts across the group of documents. The method further includes maintaining the location of each annotated fact in the group of documents and displaying the aggregated annotated facts for at least one of viewing and selecting.

In a third aspect, the present invention includes an embodiment that relates to an apparatus for viewing data. The apparatus includes means for receiving a set of documents and associated metadata based on a set of query parameters and means for determining query hits within the set of documents for a selected extraction target of a plurality of extraction targets. The apparatus also includes means for associating the query hits with the selected extraction target and means for displaying the plurality of extraction targets, each extraction target being a link to associated query hits from the set of documents.

In a fourth aspect, the present invention includes an embodiment that pertains to a computer readable storage medium on which may be embedded one or more computer programs. The one or more computer programs implement a method of viewing data. The one or more computer programs include a set of instructions for providing a plurality of documents, each document associated with annotated facts and selecting a group of documents based on a predetermined criteria. The set of instructions also include aggregating the annotated facts in the group of documents and maintaining a location of each annotated fact in the group of documents. The set of instructions further includes displaying the aggregated annotated facts for at least one of viewing and selecting.

In a fifth aspect, the present invention includes an embodiment that relates to a system for viewing data. The system includes at least one processor, a memory coupled to the at least one processor, and a viewer module configured to be stored as a computer programmable readable media in the memory and to be executed by the at least one processor. The viewer module is configured to receive a set of documents and associated metadata based on a set of query parameters and to determine query hits within the set of documents for a selected extraction target of a plurality of extraction targets. The viewer module is also configured to associate the query hits with the selected extraction target and to display the plurality of extraction targets, each extraction target being a link to associated query hits from the set of documents.

The above advantages and features are of representative embodiments only, and are presented only to assist in understanding the invention. It should be understood that they are not to be considered limitations on the invention as defined by the claims, or limitations on equivalents to the claims. Additional features and advantages of the invention will become apparent from the drawings, the following description, and the claims.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the figures, wherein:

FIG. 1 illustrates an exemplary architecture of a point-of-care (POC) viewer module in accordance with an embodiment;

FIG. 2 illustrates an exemplary flow diagram for the POC viewer module in accordance with another embodiment;

FIG. 3 illustrates a natural language patient record (NLPR) system utilizing a POC viewer module in accordance with yet another embodiment;

FIG. 4 illustrates a POC report generator GUI provided by the POC viewer module in accordance with yet another embodiment;

FIG. 5 illustrates an embodiment of the decision tree for the query bar shown in FIG. 4;

FIGS. 6A-6B illustrate a patient report based on selections made on the POC query bar GUI, shown in FIG. 4 in accordance with yet another embodiment;

FIG. 7 illustrates a medical record viewer GUI in accordance with yet another embodiment;

FIG. 8 illustrates a flow diagram for the POC record viewer module in accordance with yet another embodiment;

FIG. 9 illustrates a more detailed flow diagram of the POC viewer module, shown in FIGS. 1-3, in accordance with yet another embodiment;

FIG. 10 illustrates a flow diagram of the POC viewer module in accordance with yet another embodiment;

FIG. 11A illustrates a flow diagram of the POC viewer module in accordance with yet another embodiment;

FIG. 11B illustrates a flow diagram of the POC viewer module in accordance with yet another embodiment; and

FIG. 12 illustrates a flow diagram of the POC viewer module in accordance with yet another embodiment.

### DETAILED DESCRIPTION OF THE EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of network systems, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments relate to a mechanism for viewing data. More particularly, a point-of-care (POC) viewer may be configured to provide a mechanism for a user to search for a selected medical fact and display the data related to the selected medical fact. The POC viewer includes a query module configured to search for documents meeting specified query parameters. The documents include text of the document and metadata. The metadata may include facts, location in the document of the facts, links to related documents, etc. The host application may generate the metadata by applying an extraction module to the document. The documents may be a flat file, ASCII, a word processing file, etc. The query module may be configured to return documents that qualify under the search parameters entered by the document.

A POC module may be configured to process the returned documents and organize the selected documents and display validated natural language-based extractions for a particular subject, e.g., a patient. More particularly, the POC module may invoke an I/O module to generate a POC viewer graphical user interface (GUI). The POC viewer GUI may comprise of two main components: a summary viewer component for generating summary reports and a medical record viewer for viewing detailed information.

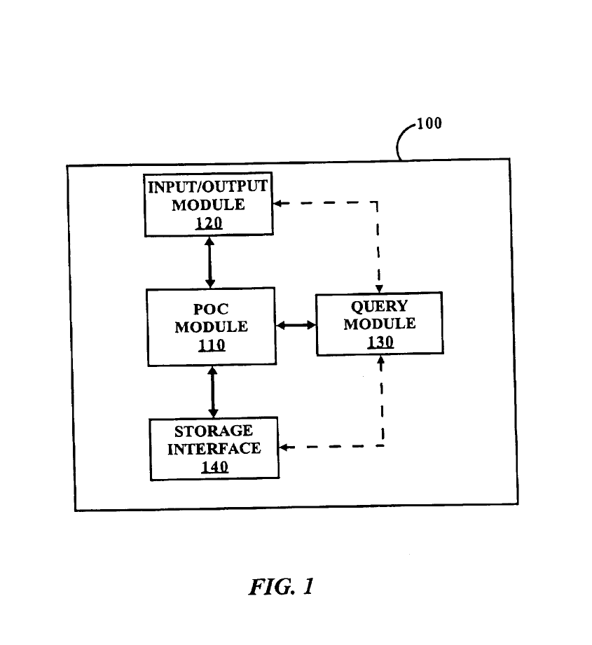

FIG. 1 illustrates an exemplary architecture of a POC viewer module 100 in accordance with an embodiment. It should be readily apparent to those of ordinary skill in the art that the exemplary architecture depicted in FIG. 1 represents a generalized schematic illustration and that other components may be added or existing components may be removed or modified.

As shown in FIG. 1, the POC viewer module 100 includes a POC module 110, an input/output (I/O) module 120, a query module 130, and a storage interface 140. The POC module 110 may be configured to provide the functionality for the POC viewer module 100. For example, the POC module 110 may be configured to perform actions in response to user input received through the I/O module 120.

The POC module 110 may also be configured to interface with the I/O module 120. The POC module 110 may invoke the I/O module 120 to provide an interface to query for document(s), to provide an interface to show extracted data from the found documents, and/or to provide an interface to show a draft document with extracted data selected for reuse. In other embodiments, the functionality of the I/O module 120 may be merged into the POC module 110.

The POC module 110 may be further configured to interface with the storage interface 140. The storage interface 140 may provide a mechanism for the POC viewer module 100 to access existing documents for querying. The storage interface 140 may be set of function calls, remote procedure calls or other similar interface.

The POC module 110 may be further configured to interface with the query module 130. The query module 130 may receive query parameters from an interface generated by the I/O module 120 to search for document or a set of documents. Alternatively, the query module 130 may receive the query parameters through the POC module 110. The query module 130 may be configured to implement a search through either the storage interface 140 directly or through the POC module 110 for the documents that match the received query parameters. For the matching documents, the query module 130 may forward the matching documents to the POC module 110. In other embodiments, the functionality of the query module 110 may be merged with the POC module 110.

The POC viewer module 100 may be implemented as a software program, a utility, a subroutine, or other similar programming entity. In this respect, the POC viewer module 100 may be implemented using software languages such as C, C++, JAVA, etc. Alternatively, the POC viewer module 100 may be implemented as an electronic device utilizing an application specific integrated circuit, discrete components, solid-state components or combination thereof.

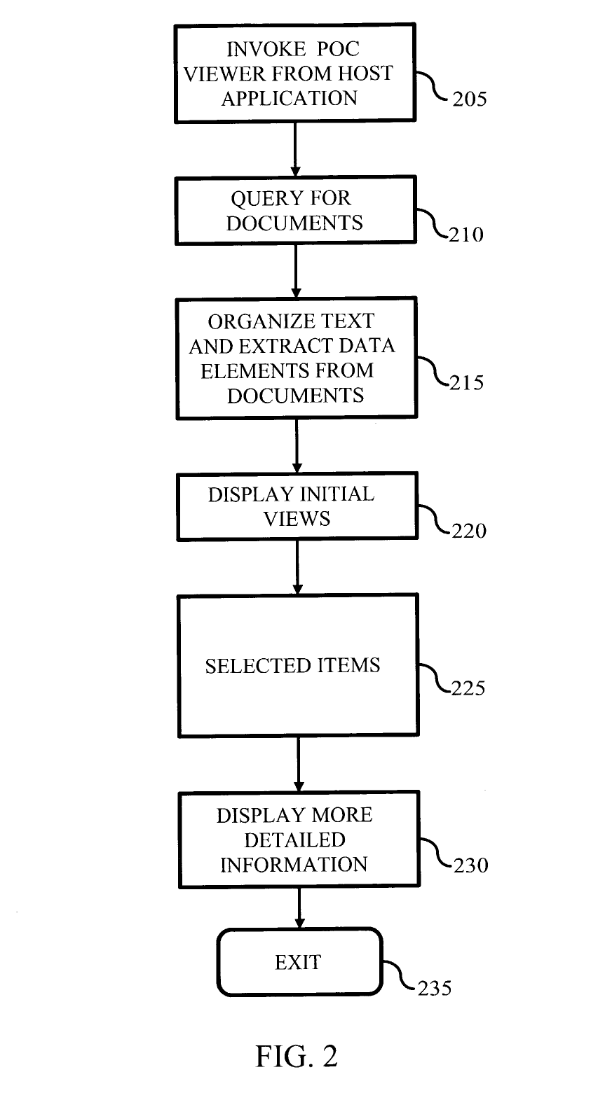

FIG. 2 illustrates an exemplary flow diagram 200 for the POC viewer module 100 in accordance with another embodiment. It should be readily apparent to those of ordinary skill in the art that this method 200 represents a generalized illustration and that other steps may be added or existing steps may be removed or modified.

As shown in FIG. 2, a host application may invoke the POC viewer module 100 by initiating a command, in step 205. Alternatively, the host application may have a menu item that represents the POC viewer 100 or by a function call. Once invoked, the POC module 110 may invoke the I/O module 120 to provide an initial graphical user interface (GUI) for a user to receive input.

In step 210, the query module 130 may initiate a search for the requested documents based on query parameters entered into the initial GUI. If matching documents are found, the query module 130 may forward the matching documents to the POC module 110. Although not shown, if no matching documents are found, the query module 130 may notify the user of the lack of matching documents through the I/O module 120.

In step 215, the POC module 110 may be configured to organize the retrieved document(s) and related extracted facts and metadata. More specifically, the POC module 110 may organize the retrieved documents according to extractions targets, e.g., problems, medications, allergies, based on the associated metadata. For example, under the extraction target of problems, the locations of terms related to problems in the retrieved documents are presented to the user. In other words, a user may be provided with the initial GUI that includes extraction target of problems as an active link. Activating the ‘problems’ link expands and displays the links for the locations in the respective links for the terms that are related to the extraction target of the ‘problem.’ Similarly, the POC module 110 determines the associated term and location of the associated term for each extraction target.

In step 220, the POC module 110 may invoke the I/O module 120 to display the extraction targets in a collapsed tree format. The I/O module 120 may be configured to expand a section group in response to a user event. The I/O module 120 may then display the links for the matching terms in the document for the respective extraction group.

In step 225, a user may select a link within an extraction target group. The POC module 110 may then be configured to display more detailed information regarding the selected link. For example, the text surrounding the activated associated term may be displayed, in step 230. Alternatively, the entire document may be displayed in a GUI window. Subsequently, in step 235, the POC viewer module 100 may exit.

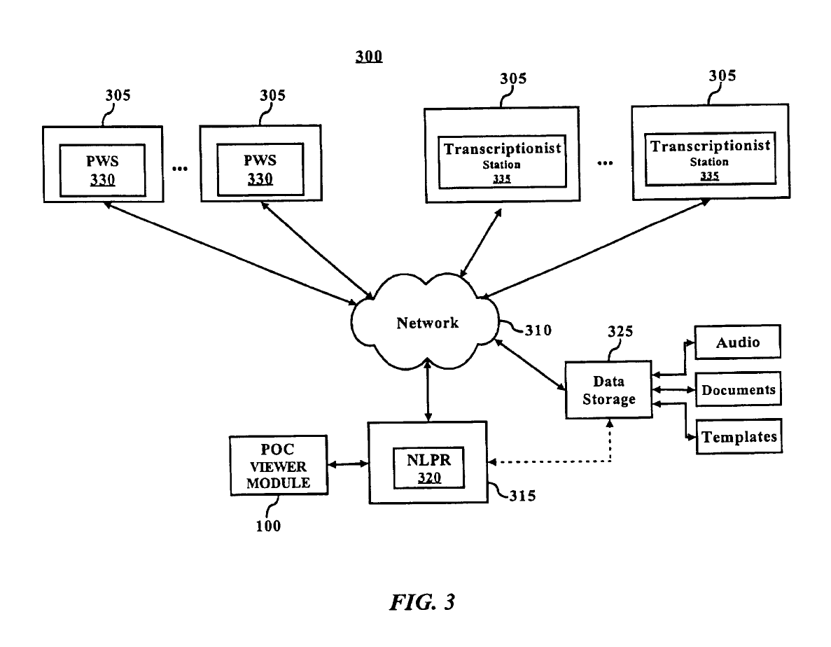

FIG. 3 illustrates a natural language patient record (NLPR) system 300 utilizing POC viewer module 100 in accordance with yet another embodiment. As shown in FIG. 3, the NLPR system 300 includes a plurality of workstations 305 interconnected by a network 310. The NLPR system 300 also includes a server 315 executing a computer readable version 320 of the NLPR system and data storage 325. The NLPR system 300 is a system for maintaining electronic medical records of patients, which is described in greater detail in co-pending U.S. patent application Ser. No. 10/______, entitled, and which is hereby incorporated by reference in its entirety.

The workstations 305 may be personal computers, laptops, workstations, or other similar computing element. The workstations 305 execute a physician workstation (PWS) client 330 from the NLPR system 300. The PWS client 325 provides the capability for a physician to dictate, review, and/or edit medical records to the NLPR system 300.

The workstations 305 also execute a transcriptionist client 335 for a transcriptionist to access and convert audio files into electronic text. The NLPR system 300 may also use speech engines to automatically convert dictations from physicians into electronic text.

The network 310 is configured to provide a communication channel between the workstations 305 and the server 315. The network 310 may be a wide area network, local area network or combination thereof. The network 310 may implement wired protocols (e.g., TCP/IP, X.25, IEEE802.3, IEEE802.5, etc.), wireless protocols (e.g., IEEE802.11, CDPD, etc.) or combination thereof.

The server 315 may be a computing device capable of providing services to the workstations 305. The server 315 may be-implemented using Compaq DL360, HP RX5670, IBM xSeries205, Sun Microsystem SunFire V1280, or other similar computing platform. The server 315 is configured to execute a computer readable version of the NLPR software 320. The NLPR software provides functionality for the NLPR system 300. The NLPR system 300 may receive audio files and/or documents by other network access means such as electronic mail, file transfer protocols, and other network transferring protocols.

The data storage 325 may be configured to interface with network 310 and provide storage services to the workstations 305 and the server 315. The data storage 325 may also be configured to store a variety of files such as audio, documents, and/or templates. In some embodiments, the data storage 325 includes a file manager (not shown) that provides services to manage and access the files stored therein. The data storage 325 may be implemented as a network-attached storage or through an interface through the server 315.

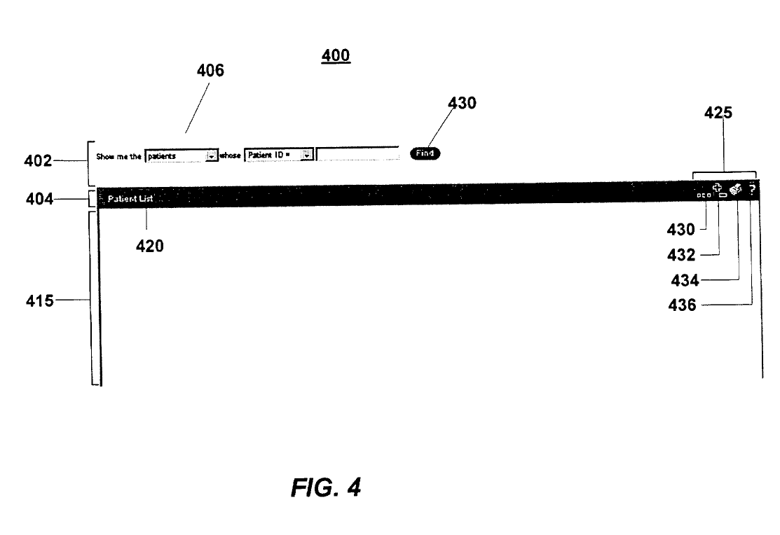

The server 315 may be further configured to interface with an embodiment of the POC viewer module 100. A user may invoke the POC viewer module 100 through a PWS client 320. For example, the POC viewer module 100 may be a menu item on a graphical user interface of the PWS client 320. Alternatively, a user may use a command line prompt at the PWS client 320 to invoke the POC viewer module 100. Once invoked, the POC viewer module 100 may display a POC report generator graphical user interface (GUI) as shown in FIG. 4.

FIG. 4 illustrates a POC report generator GUI 400 provided by the POC viewer module 100 in accordance with yet another embodiment. It should be readily apparent that the elements of the POC report generator GUI 400 may be deleted and/or modified and new elements added.

As shown in FIG. 4, the POC report generator GUI 400 includes a query bar 402, a control bar 404, and a report area 415. The POC report generator GUI 400 may be configured to permit users to view information, e.g., patient information, through various views and queries. The query bar 402 may be configured to determine and/or find information related to a patient. The control bar 404 may be configured to manipulate the display of the information found for the patient as displayed in the report area 410.

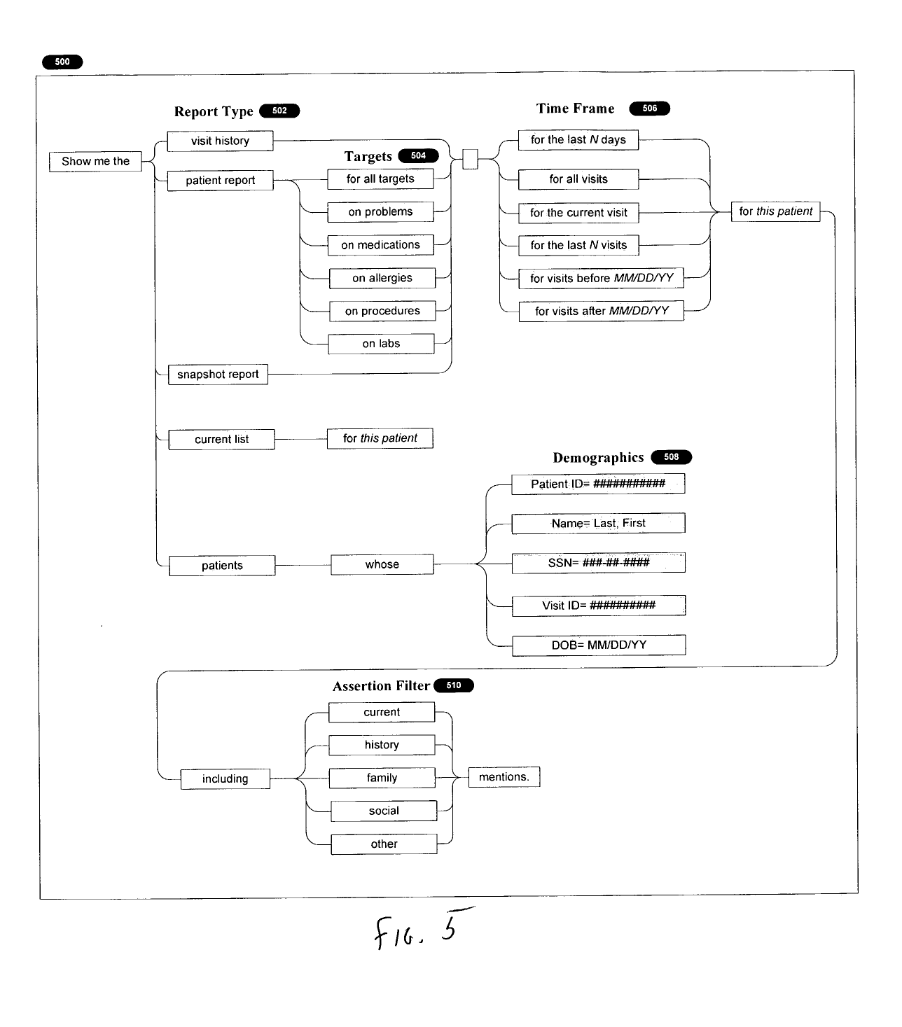

The query bar 402 includes a report dropdown 406. The report dropdown 406 may be configured to query for selected information based on a decision tree, as shown in FIG. 5. FIG. 5 illustrates an embodiment of the decision tree 500 for the report dropdown shown 406 in FIG. 4. It should be readily apparent that the elements of the decision tree 500 may be deleted and/or modified and new elements added.

As shown in FIG. 5, a user may select five types of reports 502: view history, patient report, snapshot report, current list, and patients. The target dropdown list 504 controls the target that will be displayed on the report, where target may be defined as various classes of medical information. The user may select a report on all targets, combinations of targets or one specific target. In this embodiment, the targets are “for all targets,” “on problems,” “on medication,” “on allergies,” “on procedures,” and “on labs.”

The time frame dropdown 506 may be configured to control the time frame for the visits. A user may specify the time frames from the list comprising of “for the last N days,” “for all vists,” “for the current visit,” “for the last N visists,” “for visits before MM/DD/YY,” and “for visits after MM/DD/YY.”

A demographics dropdown 508 may be accessed by selecting report type of “patients.” The demographics dropdown 508 may be configured to select the parameter used to query the patient list. For example, in one embodiment, the parameters include “patient ID,” “Name,” “social security number,” “visit ID,” and “date of birth.”

An assertion filter 510 may be configured to affect which assertion types are shown in the output. An assertion type is a classification of a target into a category, based on the output status. In one embodiment, the assertion filter 510 includes at least the parameters of “current,” “history,” “family,” “social,” “all,” and “other.”

Returning to FIG. 4, the query bar 402 may also be configured to have default settings. More particularly, if the patient information is not known, then the report dropdown 406 will have the patient lookup query selected. Using this query will not affect the “last saved query” stored in user preferences. If the patent information is known and the user has set that the last query used be a default, then the last query saved in the user's preference information will be shown. When a new query is made, the new query will be saved in the user's preference information.

Otherwise, if there is a default query stored in the user's preference information, the default query will be shown in the report dropdown 406. Otherwise, a default query defined for the POC viewer module 100 will be shown.

The control bar 404 may be configured to include a report heading 420 and a button bar 425. The button bar 425 may comprise of an “Elide/Show All Text” button 430, an “Expand/Collapse All” button 432, a “user preference” button (not shown), a “print” button 434, and a “help” button 436.

The “Elide/Show All Text” button 430 may be configured to allow users to either elide or show all the text in lines that could wrap. The “Expand/Collapse All” button 432 may be configured to allow a user to expand or collapse entries in the report. Activating the appropriate part of the control will perform the collapse or expand operation. The “user preference” button may be configured to present as an icon that allows users to modify the appearance of the POC report generator GUI 400. Activating this icon will display a user preference dialog with the POC report generator GUI 400 component preferences in a tree control. The “print” button 434 may be configured to allow user to print the report.

The “help” button 436 may be configured to allow users to display help information for the POC viewer. Help pages are created to explain the content of each view, how to use the query bar, and how to customize the pages. These pages will be accessible from the “help” button 436. The “help” button 436 may be configured to display information relevant to the currently selected report type.

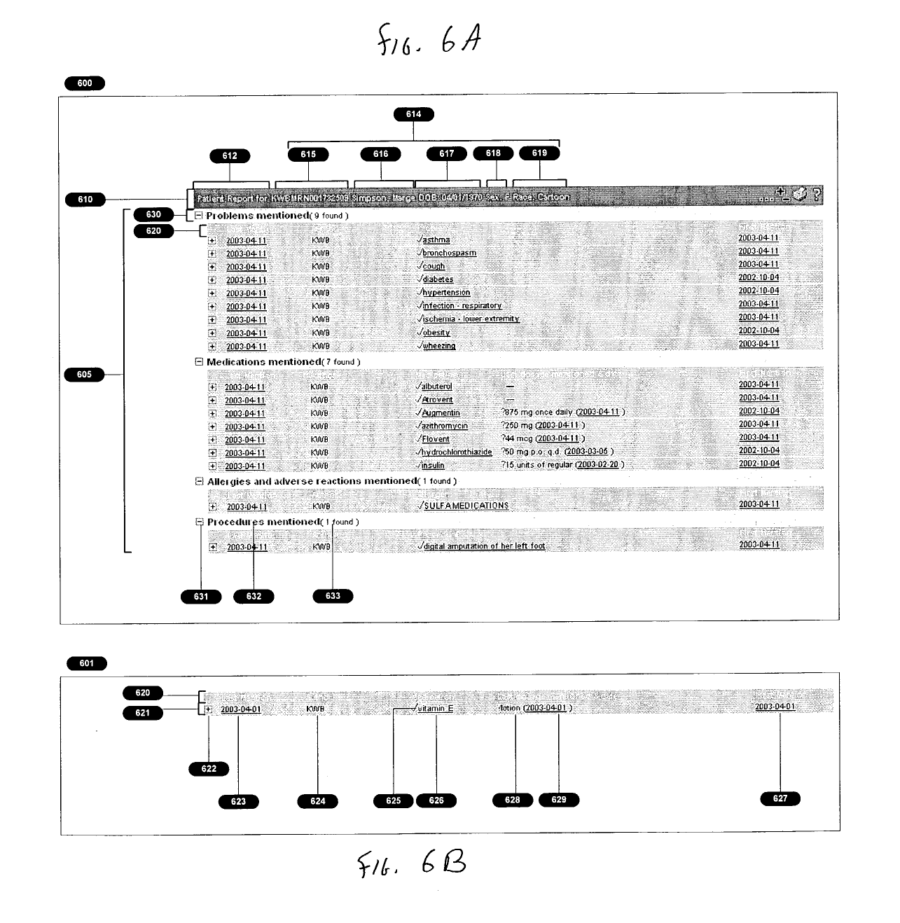

FIGS. 6A and 6B illustrate a patient report based on selections made on the POC report generator GUI 400, shown in FIG. 4 in accordance with yet another embodiment. As shown in FIG. 6, a report may comprise the control bar 610 with the report heading 612 shown in the control bar 610 and the detail for each extraction shown in the report window 605.

The report heading 612 may comprise a report title and patient demographics 614. More particularly, if only one extraction target is selected in the target dropdown list (see FIG. 5), then the POC report generator GUI 400 is configured to generate the report title of “Patient Report on [selected target]”. Patient demographics 614 may comprise patient name (last name 615, first name 616), a date of birth 617, sex 618, and race 619.

If the all targets are selected from the target dropdown list 504, then the POC report generator 400 may be configured to display each target name (e.g., Problems, Medications, Allergies and adverse reactions, Procedures, etc.) as a top-level of a tree menu 630. The order of the targets may be user-defined. A user may select the order of the targets and save the order in the user preferences. However, if only one target is selected in the target dropdown list 504, then the POC report generator GUI 400 does not list the target name as a top-level item. The POC report generator 400 may be configured to precede the top level items, e.g., Problems, Medications, etc., with an expand/collapse icon 631. The POC report generator 400 may expand or collapse the tree in response to activating the expand/collapse icon 631.

The POC report generator GUI 400 may also be configured to present the text of the target name 632 in bold. Alternatively, the POC report generator GUI 400 may present the text in a user-selected style as saved in the user-preferences. The POC report generator 400 may be further configured to present a count 633 of the individual extraction target items found for that patient within the restrictions of the user's query. If targets are specified where no facts were found, the POC report generator GUI 400 may be configured to display the targets as top-level items but followed with “0 found” for the count 633.

The POC report generator GUI 400 may be further configured to display a heading row 620. The heading row 620 is configured to appear under each target when multiple targets are shown or will appear when only one target is selected. Under the heading row, a row for each fact found for the selected target is displayed by the POC report generator GUI 400. In the event that no facts were found, when the row is expanded, the text “none found” is displayed by the POC report generator GUI 400. The POC report generator 400 may also display a first mention date field 623, an ID and/or a department of the author of the author that mentions the fact field 624, a validation status of the fact field 625, a normalized or categorized name of the fact field 626, and its last mention date field 627. The last mentioned dosage field 628 and the date for which dosage was mentioned field 629 may be further displayed by the POC report generator GUI 400 for targets of the type “medications”.

The last mention date 625 field may be configured to indicate the date that the target was last mentioned in any known report for the selected patient. The information related to the last mention date 625 is not based on the user specified time span. If a user activates the last mention date 625, a medical record viewer (described below) is instantiated in a pop-up window, with the record where the last mentioned was made selected, and the first extraction target item will be visible and highlighted in the medical record viewer.

The first mention date 623 field may be configured to indicate the date that the target was first mentioned in any known report for the selected patient. The information related to the first mention date 623 is not based on the user specified time span. If a user activates the first mention date 623, a medical record viewer (described below) is instantiated in a pop-up window, with the record where the first mentioned was made selected, and the first extraction target item will be visible and highlighted in the medical record viewer.

The author 624 field may be configured to indicate the ID and/or department of the author of the document containing the last mention. The author is the creator of the first revision of the document.

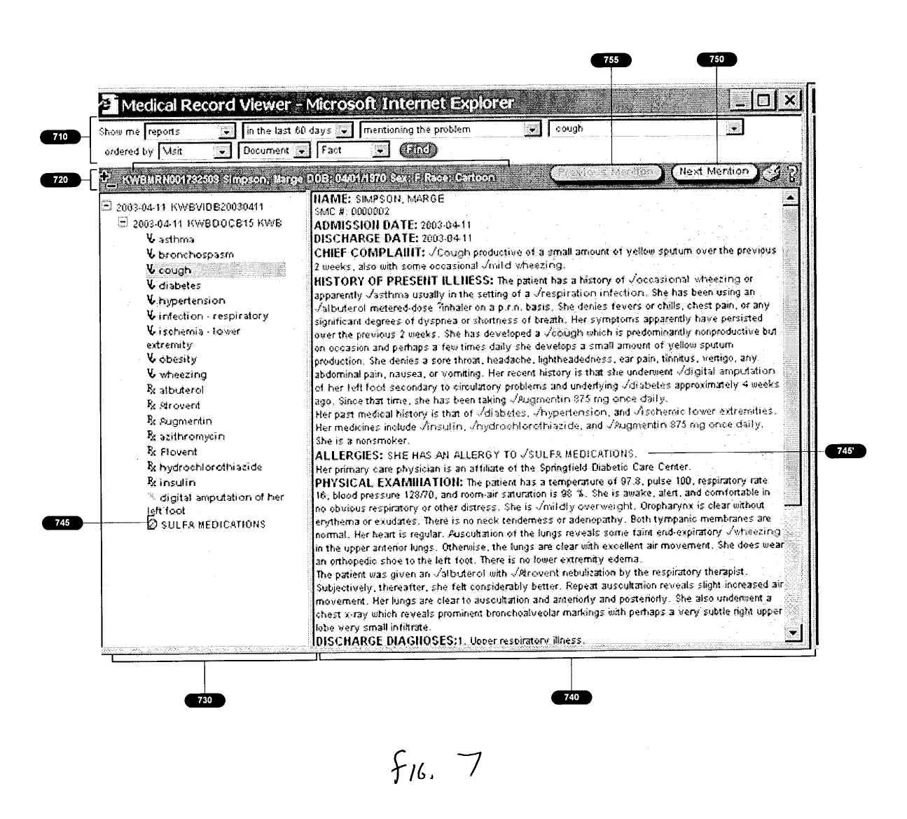

FIG. 7 illustrates a medical record viewer GUI 700 in accordance with yet another embodiment. The medical record viewer GUI 700 provides a link for a user to view the source information (or material) for information displayed by the POC report generator GUI 400. More particularly, the medical record viewer GUI 700 functions with a collection of medical records specified by the POC report generator GUI 400, i.e., the records retrieved during the query process. The medical record viewer GUI 700 is a modal dialogue that locks the user in the medical record viewer GUI 700.

As shown in FIG. 7, the medical record viewer GUI 700 comprises a query bar 710, a control bar 720, a navigation tree 730, and a document view 740. The medical record viewer GUI 700 may be configured to display the extracted target items in the navigation tree 730. Users may select a leaf node in the tree control 745 and the corresponding extracted target items are highlighted 745′ within the respective document context in the document view 740. Activating the next mention 750 or the previous mention 755 configures the medical record viewer GUI 700 to show the next/previous mention within the set of documents that mentions the item. Upon reaching the last mention in a report, the next mention 750 may be configured to change to a “Next Document” button. Similarly, upon reaching the first mention in a report, the previous mention button 755 may be configured to change to a “Previous Document” button. The medical record viewer GUI 700 may also be configured to highlight each mention in the document view 740 and to show the associated validation status for the mention.

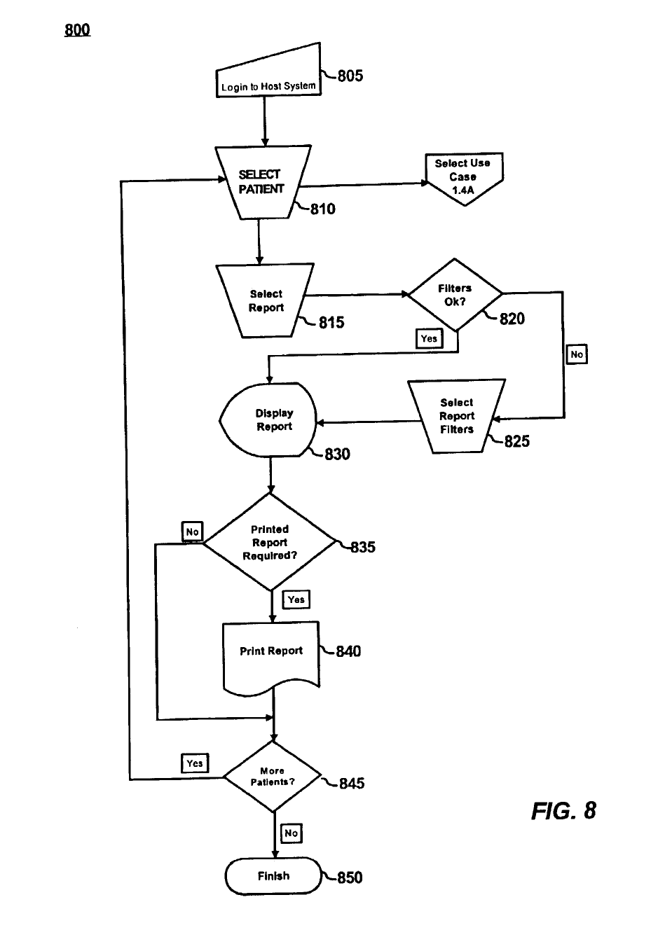

FIG. 8 illustrates a flow diagram for the POC record viewer module 100 in accordance with yet another embodiment. It should be readily apparent to those of ordinary skill in the art that this flow diagram 800 represents a generalized illustration and that other steps may be added or existing steps may be removed or modified.

As shown in FIG. 8, a user may initiate a session with a host application, e.g., NLPR system 300 shown in FIG. 3, in step 805. The user may then instantiate the POC record viewer module 100 by activating an icon, selecting a menu item or executing a command.

In step 810, a user may select a patient from the host application, e.g., NLPR system 300. More particularly, the POC record viewer module 100 may generate and display the POC report generator GUI 400 (shown in FIG. 4).

In step 815, a user may manually select a preferred report from the control bar 404 of the POC report generator GUI 400. The POC report generator GUI 400 may permit the user to select the query parameters for the report and allow the user to confirm the selected query parameters, in step 820. If the user is satisfied with the selected query parameters, the user may activate the Find button 430 on the POC report generator GUI 400, in step 825. Otherwise, the user may alter the selected query parameters, in step 830. Subsequently, the use may activate the Find button 430 to create a report based on the selected query parameters.

In step 830, the POC viewer module 100 may configure the POC report generator GUI 400 to display the results of the selected query parameters. In step 835, the POC viewer module 100 determines whether a hardcopy of the report is required. If a hardcopy of the report is needed, the POC viewer module 100 may initiate a print spool job or directly send the report to be printed at a local printer, in step 840.

Otherwise, the POC viewer module 100 may be configured to determine from the POC report generator GUI 400 whether or not additional patients are to be selected, in step 845. If additional patient is selected, the POC viewer module 100 returns to the processing of step 810. Otherwise, the POC viewer module 100 may be configured to close the POC report generator GUI 400 and exit, in step 850.

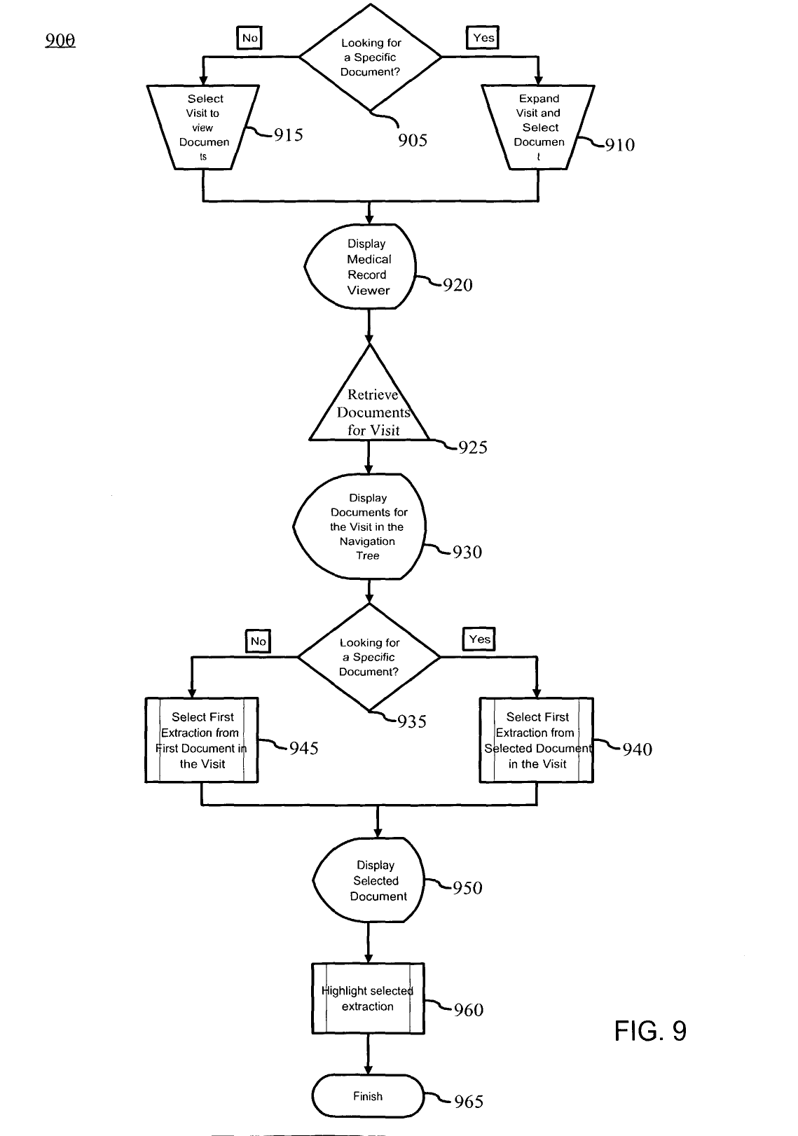

FIG. 9 illustrates a more detailed flow diagram 900 of the POC viewer module 100, shown in FIGS. 1-3, in accordance with yet another embodiment. It should be readily apparent to those of ordinary skill in the art that this flow diagram 900 represents a generalized illustration and that other steps may be added or existing steps may be removed or modified. In FIG. 9, a user has already initiated a query based on visit identification through the POC report generator GUI 400 (shown in FIG. 4).

As shown in FIG. 9, the POC viewer module 100 may be configured to determine from the user whether or not the user is searching for a specific document by waiting for an input on the POC report generator GUI 400, in step 905. If the user is searching for a specific document, the POC viewer module 100 waits for an input from the user that expands the visit filter parameter through the POC report generator GUI 400, in step 910. Otherwise, if the user is not searching for a specific document, the user may activate the link on the POC report generator GUI 400 for the selected visit to view documents for that visit, in step 915.

In step 920, the POC viewer module 100 may activate the medical records viewer GUI 700 (shown in FIG. 7) in response to activation of a selected document. The medical records viewer GUI 700 may be configured to retrieve the found documents for the visit query, in step 925.

In step 930, the POC viewer module 100 may configure the medical records viewer GUI 700 to display the selected documents where the extracted target items are nodes of a tree control.

In step 935, the POC viewer module 100 may be configured to determine whether the user is looking for a specific document based on the input selection on the medical records viewer GUI 700. If the user selects a specific document, in step 940, the medical records viewer GUI 700 may display the selected document in the document view 740, in step 950.

Otherwise, in step 945, the medical records viewer GUI 700 may be configured to select the first extraction of the first document of the set of found documents. Subsequently, in step 950, the medical records viewer GUI 700 may display the selected document in the document view. In step 950, the medical records viewer GUI 700 may be configured to highlight the selected fact from either step 940 or 945. Subsequently, the medical record viewer GUI 700 may terminate based on user activation of the exit function.

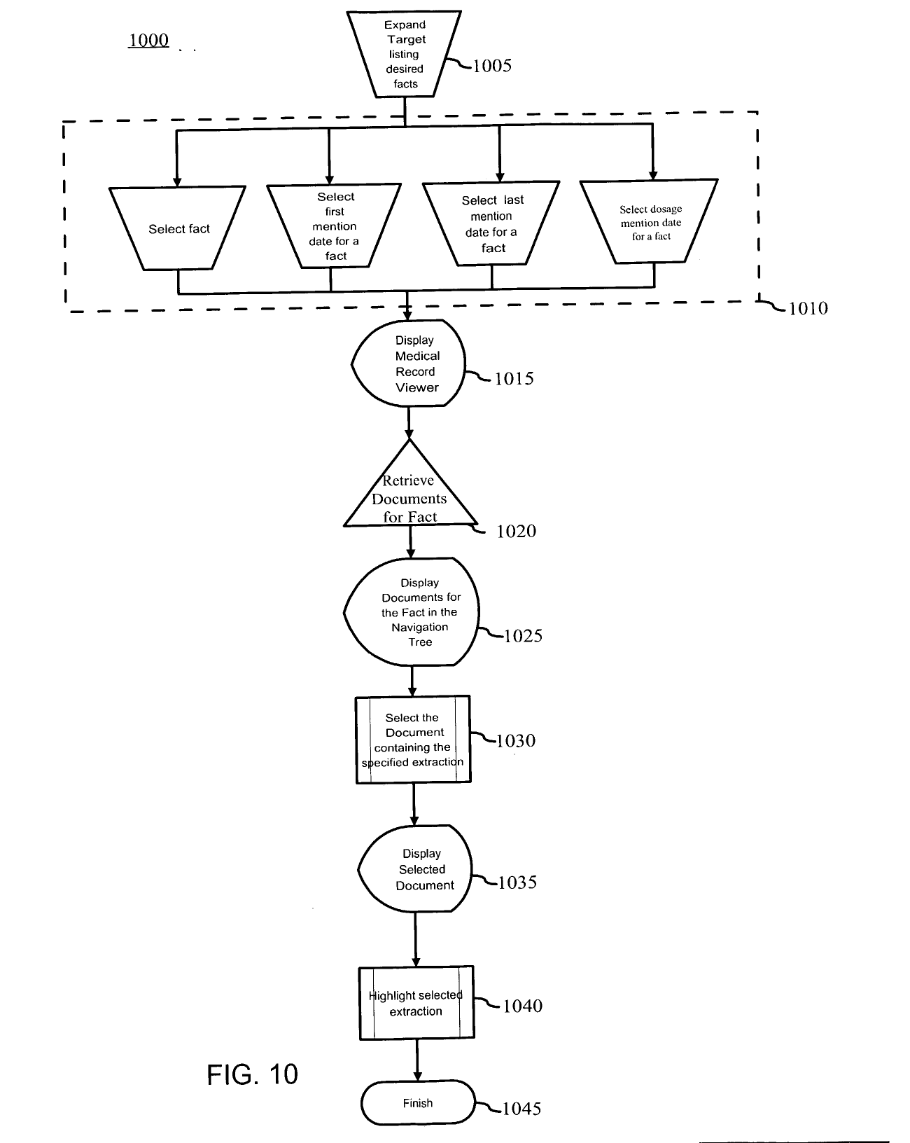

FIG. 10 illustrates a flow diagram 1000 of the POC viewer module 100 in accordance with yet another embodiment. It should be readily apparent to those of ordinary skill in the art that this flow diagram 1000 represents a generalized illustration and that other steps may be added or existing steps may be removed or modified. In FIG. 10, a user has initiated a requested report through the POC report generator GUI 400 (shown in FIG. 4).

As shown in FIG. 10, the POC viewer module 100 may be configured to receive an input through the POC report generator GUI 400 that the user has selected a target, in step 1005. The POC viewer module 100 may configure the POC report generator GUI 400 to display links for the selected fact. In one embodiment, the links may be fact, first mention date for a fact, last mention date for a fact, and dosage mention date for a fact (in the case where the fact is a medication).

In step 1010, the POC viewer module 100 receives an indication that one of the links has been activated. In step 1015, the POC viewer module 100 may instantiate the medical records viewer GUI 700 in response to the selection of the link in step 1010.

In step 1020, the medical records viewer GUI 700 may be configured to assemble the retrieved documents. In step 1025, the POC viewer module 100 may configure the medical records viewer GUI 700 to display the selected documents in the navigation tree 730, where the extracted target items are nodes of a tree control.

In step 1030, the POC viewer module 100 may be configured to select a document containing a selected extraction based on a user selection on the medical records viewer GUI 700. Subsequently, in step 1035, the medical records viewer GUI 700 may display the selected document in the document view.

In step 1040, the medical records viewer GUI 700 may be configured to highlight the selected extraction. Subsequently, the medical record viewer GUI 700 may terminate based on user activation of the exit function, in step 1045.

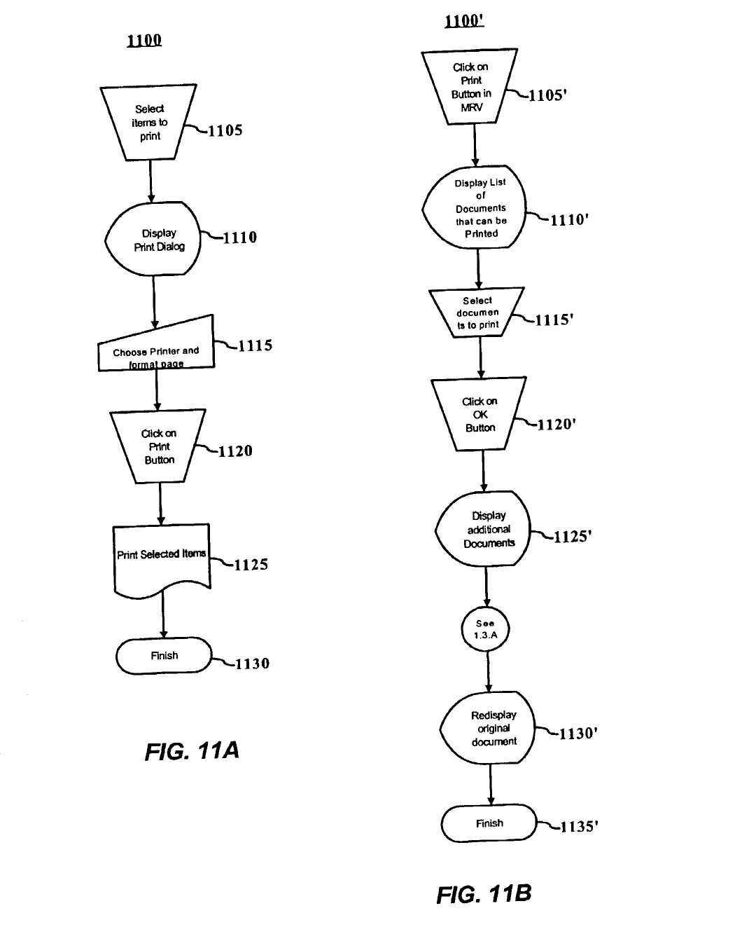

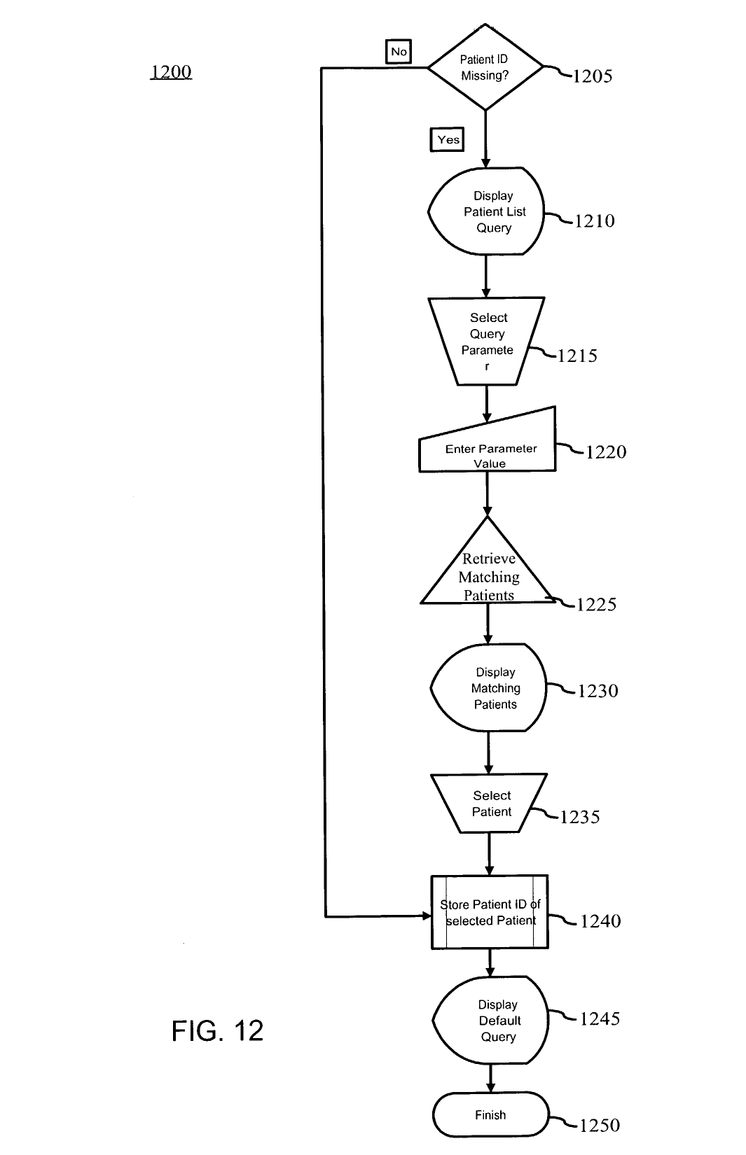

FIG. 11A illustrates a flow diagram 1100 of the POC viewer module 100 in accordance with yet another embodiment. It should be readily apparent to those of ordinary skill in the art that this flow diagram 1100 represents a generalized illustration and that other steps may be added or existing steps may be removed or modified. In FIG. 11A, a user has initiated a requested report through the POC report generator GUI 400 (shown in FIG. 4).

As shown in FIG. 11A, the POC viewer module 100 may be configured to receive input from the POC report generator GUI 400 that a user has selected one or more documents for printing, in step 1105.

In step 1110, the POC viewer module 100 may display a print dialog box to permit the user to format the print job. In step 1115, the POC viewer module 100 may receive input from the user changing the printer or page format, if any, through the print dialog box.

In step 1120, the POC viewer module 100 may receive indication that the user has activate the print icon 434. In step 1125 the POC viewer module 100 may call the appropriate functions to print the selected documents according to the underlying operating system (UNIX, WINDOWS, LINUX, etc.). Subsequently, the POC viewer module 100 may return to an idle state, in step 1130.

FIG. 11B illustrates a flow diagram 1100′ of the POC viewer module 100 in accordance with yet another embodiment. It should be readily apparent to those of ordinary skill in the art that this flow diagram 1100′ represents a generalized illustration and that other steps may be added or existing steps may be removed or modified. In FIG. 11B, a user has initiated a requested report through the POC report generator GUI 400 (shown in FIG. 4) and is viewing a selected document in the medical records viewer GUI 700 (shown in FIG. 7).

As shown in 11B, the POC viewer module 100 may receive an indication from the medical records viewer GUI 700 that a user has activated the Print button 434, in step 1105′. The POC viewer module 100 may configured the medical records viewer GUI 700 to display a list of reports that can be printed, with the currently displayed report already selected, in step 1110′.

In step 1115′, the POC viewer module 100 may receive the selection of the documents to be printed from the user through the medical records viewer GUI 700, if any. In step 1120′, the POC viewer module 100 may receive indication to print the selected documents by activation of an OK button on the medical records viewer GUI 700.

In step 1125′, the POC viewer module 100 may configure the medical records viewer GUI 700 to display the selected documents, if any, in the document view 740. Subsequently, the POC viewer module 100 may pass the selected documents to the processing of flow diagram 1100 (shown in FIG. 11A).

In step 1130′, the POC viewer module 100 may configure the medical records viewer GUI 700 to redisplay the original document. Subsequently, the POC viewer module 100 may finish, in step 1135′.

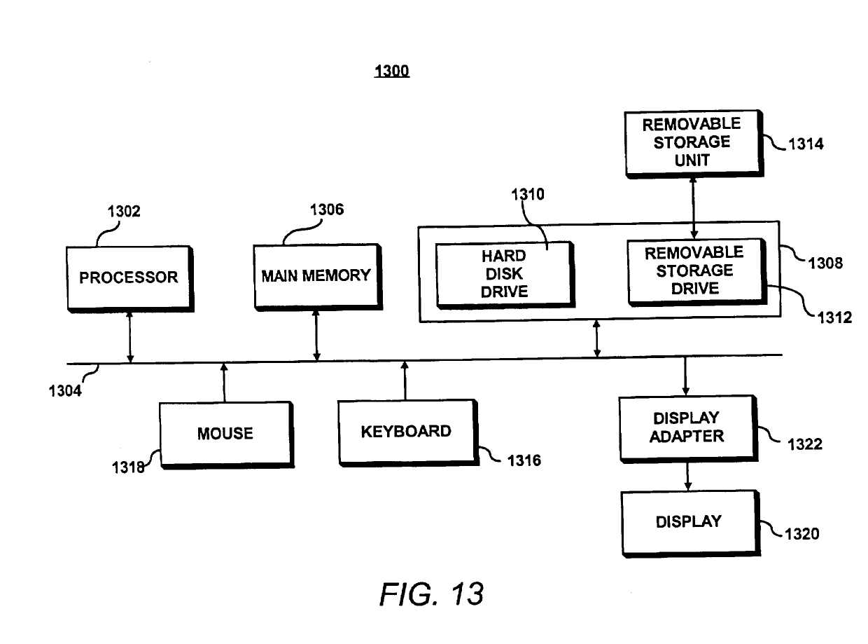

FIG. 12 illustrates a flow diagram 1200 of the POC viewer module 100 in accordance with yet another embodiment. It should be readily apparent to those of ordinary skill in the art that this flow diagram 1200 represents a generalized illustration and that other steps may be added or existing steps may be removed or modified. In FIG. 12, a user has initiated a request for a report on a patient but has not provided the patient ID through the POC report generator GUI 400 (shown in FIG. 4).

As shown in FIG. 12, in step 1205, the POC viewer module 100 determines whether or not the patient ID has been entered. If the patient ID has been entered, the POC viewer module 100 proceeds to the processing of step 1240, which is discussed below. Otherwise, if the patient ID has not been entered, the POC viewer module 100 may configure the POC report generator GUI 700 to display a patient list query dialog, in step 1210.

In step 1215, the POC viewer module 100 receives indication of what type of input that the user would like to enter regarding the identifying information of the patient, e.g. name, ID, SSN, etc., through the patient list query dialog. In step 1220, the POC viewer module 100 receives input regarding the identifying information of the patient.

In step 1225, the POC viewer module 100 may query the host application for a list of patients matching the selected query parameters from step 1220. In step 1230, the POC viewer module 100 may configure the POC report generator GUI 400 to display the results of the search.

In step 1235, the POC viewer module 100 receives the selection of a patient from the user through the POC report generator GUI 400. In step 1240, the POC viewer module 100 may store the selected patient ID. In step 1245, the POC viewer module 100 may set the query to default. Subsequently, the POC viewer module 100 finishes, in step 1250.

FIG. 13 illustrates an exemplary block diagram of a computer system 1300 where an embodiment may be practiced. The functions of the expressway routing module may be implemented in program code and executed by the computer system 1300. The POC viewer module 100 and the NLPR system 300 may be implemented in computer languages such as PASCAL, C, C++, JAVA, etc.

As shown in FIG. 13, the computer system 1300 includes one or more processors, such as processor 1302, that provide an execution platform for embodiments of the POC viewer module 100. Commands and data from the processor 1302 are communicated over a communication bus 1304. The computer system 1300 also includes a main memory 1306, such as a Random Access Memory (RAM), where the software for the POC viewer module 100 may be executed during runtime, and a secondary memory 1308. The secondary memory 1308 includes, for example, a hard disk drive 1320 and/or a removable storage drive 1322, representing a floppy diskette drive, a magnetic tape drive, a compact disk drive, etc., where a copy of a computer program embodiment for the POC viewer module 100 may be stored. The removable storage drive 1322 reads from and/or writes to a removable storage unit 1324 in a well-known manner. A user interfaces with the the POC viewer module 100 with a keyboard 1326, a mouse 1328, and a display 1320. The display adaptor 1322 interfaces with the communication bus 1304 and the display 1320 and receives display data from the processor 1302 and converts the display data into display commands for the display 1320.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of viewing data, the method comprising the steps of:
receiving a set of documents and associated metadata based on a set of query parameters;
determining query hits within the set of documents for a selected extraction target of a plurality of extraction targets;
associating the query hits with the selected extraction target; and
displaying the plurality of extraction targets, each extraction target being a link to associated query hits from the set of documents.

2. The method according to claim 1, further comprising the steps of:
activating the selected extraction target; and
displaying the associated query hits for the selected extraction in response to the activation, wherein the associated query hits determined from the associated metadata of the documents.

3. The method according to claim 2, further comprising the steps of:
activating a selected associated query hit of the associated query hits; and
displaying context information related to the selected associated query hit.

4. The method according to claim 1, further comprising the step of linking the selected extraction target with the query hits and associated metadata.

5. The method according to claim 1, wherein the query hits is determined based on comparing metadata associated of the set of documents.

6. A method of viewing data, the method comprising the steps of:
providing a plurality of documents, each document associated with annotated facts;
selecting a group of documents based on a predetermined criteria;
aggregating the annotated facts in the group of documents;
maintaining a location of each annotated fact in the group of documents; and
displaying the aggregated annotated facts for at least one of viewing and selecting.

7. The method according to claim 6, further comprising the step of organizing the aggregated annotated facts into a plurality of filtered annotated facts group, each group associated with a respective category and filtered annotated facts.

8. The method according to claim 7, further comprising the step of linking annotated facts within each group of the plurality of filtered annotated facts groups based on validity.

9. The method according to claim 7, further comprising the step of linking annotated facts within each group of the plurality of filtered annotated facts groups based on temporal significance.

10. The method according to claim 7, further comprising the step of linking annotated facts within each group of the plurality of filtered annotated facts groups based on relevance.

11. The method according to claim 7, further comprising the step of displaying the plurality of groups of filtered annotated facts groups as top-level menu tree, each group represented as an active link.

12. The method according to claim 11, further comprising the steps of:
activating a selected group of filtered annotated facts groups; and
displaying associated filtered annotated facts in response to the activation of the selected group, each associated filtered annotated fact displayed as an embedded link.

13. An apparatus for viewing data, the apparatus comprising:
means for receiving a set of documents and associated metadata based on a set of query parameters;
means for determining query hits within the set of documents for a selected extraction target of a plurality of extraction targets;
means for associating the query hits with the selected extraction target; and
means for displaying the plurality of extraction targets, each extraction target being a link to associated query hits from the set of documents.

14. The apparatus according to claim 13, further comprising:
means for activating the selected extraction target; and
means for displaying the associated query hits for the selected extraction in response to the activation, wherein the associated query hits determined from the associated metadata of the documents.

15. The apparatus according to claim 14, further comprising:
means for activating a selected associated query hit of the associated query hits; and
means for displaying context information related to the selected associated query hit.

16. The apparatus according to claim 13, further comprising a means for linking the selected extraction target with the query hits and associated metadata.

17. The apparatus according to claim 13, wherein the query hits is determined based on comparing metadata associated of the set of documents.

18. A computer readable storage medium on which is embedded one or more computer programs, the one or more computer programs implementing a method of viewing data, the one or more computer programs comprising a set of instructions for:
providing a plurality of documents, each document associated with annotated facts;
selecting a group of documents based on a predetermined criteria;
aggregating the annotated facts in the group of documents;
maintaining a location of each annotated fact in the group of documents; and
displaying the aggregated annotated facts for at least one of viewing and selecting.

19. The computer readable storage medium in according to claim 18, the set of instructions further comprising organizing the aggregated annotated facts into a plurality of filtered annotated facts group, each group associated with a respective category and filtered annotated facts.

20. The computer readable storage medium in according to claim 19, the set of instructions further comprising linking annotated facts within each group of the plurality of filtered annotated facts groups based on validity.

21. The computer readable storage medium in according to claim 19, the set of instructions further comprising linking annotated facts within each group of the plurality of filtered annotated facts groups based on temporal significance.

22. The computer readable storage medium in according to claim 19, the set of instructions further comprising linking annotated facts within each group of the plurality of filtered annotated facts groups based on relevance.

23. The computer readable storage medium in according to claim 19, the set of instructions further comprising displaying the plurality of groups of filtered annotated facts groups as top-level menu tree, each group represented as an active link.

24. The computer readable storage medium in according to claim 23, the set of instructions further comprising:
activating a selected group of filtered annotated facts groups; and
displaying associated filtered annotated facts in response to the activation of the selected group, each associated filtered annotated fact displayed as an embedded link.

25. A system for reusing data, the system comprising:
at least one processor;
a memory coupled to the at least one processor; and
a viewer module configured to be stored as a computer programmable readable media in the memory and to be executed by the at least one processor, wherein the viewer module also configured to receive a set of documents and associated metadata based on a set of query parameters, determine query hits within the set of documents for a selected extraction target of a plurality of extraction targets, associate the query hits with the selected extraction target, and display the plurality of extraction targets, each extraction target being a link to associated query hits from the set of documents.

26. The system according to claim 25, wherein the viewer module is further configured to receive activation of the selected extraction target and to display the associated query hits for the selected extraction in response to the activation, wherein the associated query hits determined from the associated metadata of the documents.

27. The system according to 26, wherein the viewer module is further configured to receive activation of a selected associated query hit of the associated query hits and to display context information related to the selected associated query hit.

28. The system according to 24, wherein the viewer module is further configured to link the selected extraction target with the query hits and associated metadata.

29. The system according to 25, wherein the query hits is determined based on comparing metadata associated of the set of documents.
